(19) United States
(12) Patent Application Publication
(10) Pub. No.: US 2015/0013344 A1
(43) Pub. Date: Jan. 15, 2015

(54) TUBE

(71) Applicant: United Technologies Corporation, Hartford, CT (US)

(72) Inventors: Pawel Socha, Manchester, CT (US); Venu Ponnala, East Hampton, CT (US); Usman Khan, Manchester, CT (US); Ryan Snyder, Glastonbury, CT (US)

(21) Appl. No.: 14/323,763

(22) Filed: Jul. 3, 2014

Related U.S. Application Data
(60) Provisional application No. 61/846,267, filed on Jul. 15, 2013.

(51) Int. Cl. F16L 9/00; F02C 7/32; F16L 9/02

(52) U.S. Cl. CPC F16L 9/006; F16L 9/02; F02C 7/32
USPC 60/796; 138/177; 138/171

(57) ABSTRACT

The present disclosure relates generally to the field of tubes for carrying fluids. More specifically, the present disclosure relates to a tube having an oval shaped cross-section. In some embodiments, the tube with oval cross-section comprises a tube within a cavity in a gas turbine engine.

### CROSS REFERENCE TO RELATED APPLICATION

This application claims the benefit of and incorporates by reference herein the disclosure of U.S. Ser. No. 61/846,267, filed Jul. 15, 2013.

### TECHNICAL FIELD OF THE DISCLOSURE

The present disclosure is generally related to tubes.

### BACKGROUND OF THE DISCLOSURE

Tubes are used to direct the flow of fluids (gases and/or liquids) in a great variety of applications. For example, a gas turbine engine includes a variety of cavities, such as vanes and struts, which help to direct the flow of gases through the engine. Many of these cavities comprise airfoils that include internal tubes that carry fluids to the bearing compartments. The shape of the cavity constrains the dimensions of the tube within, with predetermined minimum tube-to-inner cavity wall clearances established under all operational deflections and part tolerances. Minimal pressure loss along the length of the tube is desired while maintaining the desired clearances.

FIGS. 1A and B schematically illustrate tube designs having a diamond shaped cross-section and indicated generally at 10a and 10b, respectively. As shown in FIG. 1A, the diamond shaped tube 10a has two sections 12a of tight radius at opposing ends and two sections 14a of larger radius midway between the sections 12a. The transitional areas 16a between adjacent sections 12a and 14a are linear. As shown in FIG. 1B, the diamond shaped tube 10b has two sections 12b of tight radius at opposing ends, a section 15a of a first larger radius midway between the sections 12a on a first side 17, and a section 15b of a second larger radius midway between the sections 12a on a second side 18. The transitional areas 16b between adjacent sections 12b and 15a are linear, as are the transitional areas 16c between adjacent sections 12b and 15b.

FIG. 2 schematically illustrates a tube design having a racetrack shaped cross-section and indicated generally at 20. The racetrack shaped tube has two sections 22 of equivalent radius at opposing ends. The transitional areas 24 between the sections 22 are linear.

The structural strength of a tube depends greatly on the chosen geometry. Improvements in tube design are therefore desired in the art.

### SUMMARY OF THE DISCLOSURE

In one embodiment, a tube is disclosed, comprising: a tube body having a cross-sectional shape; wherein the cross-sectional shape comprises an oval.

In another embodiment, a gas turbine engine vane is disclosed, comprising: an airfoil; and a tube disposed at least partially within the airfoil, the tube comprising: a tube body having a cross-sectional shape; wherein the cross-sectional shape comprises an oval.

In another embodiment, a gas turbine engine strut is disclosed, comprising: an airfoil; and a tube disposed at least partially within the airfoil, the tube comprising: a tube body having a cross-sectional shape; wherein the cross-sectional shape comprises an oval.

Other embodiments are also disclosed.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic cross-sectional view of a tube with a diamond shaped cross-section in an embodiment.

FIG. 2 is a schematic cross-sectional view of a tube with a racetrack shaped cross-section in an embodiment.

FIG. 3 is a schematic cross-sectional view of a tube with an oval shaped cross-section in an embodiment.

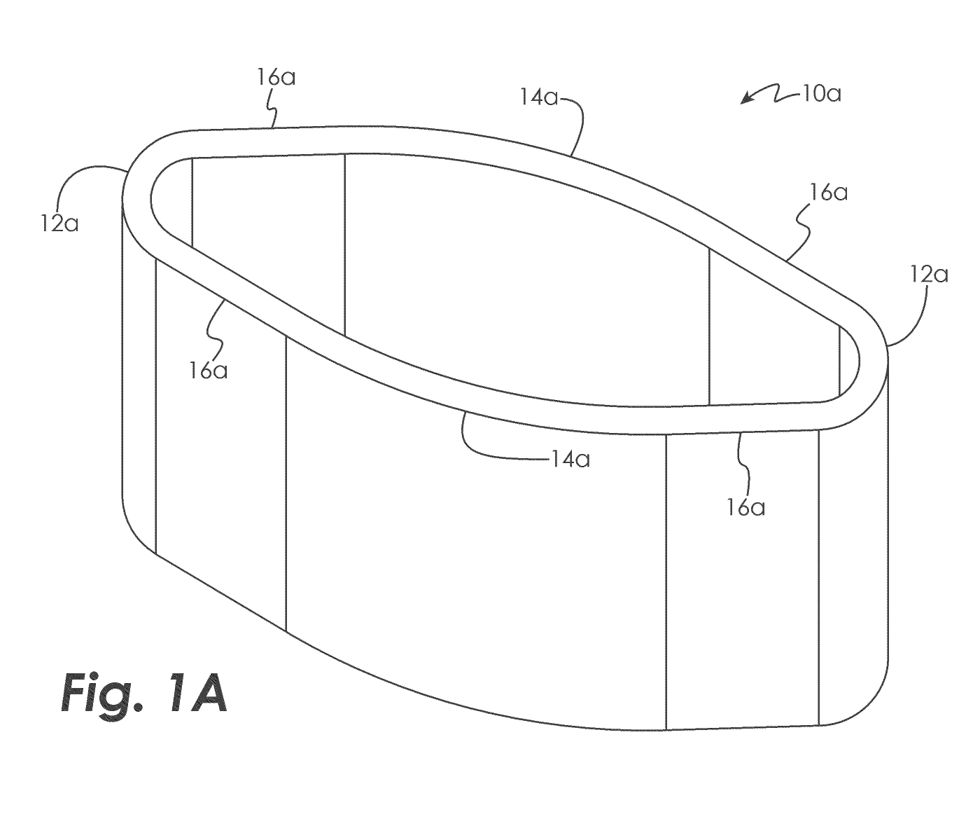

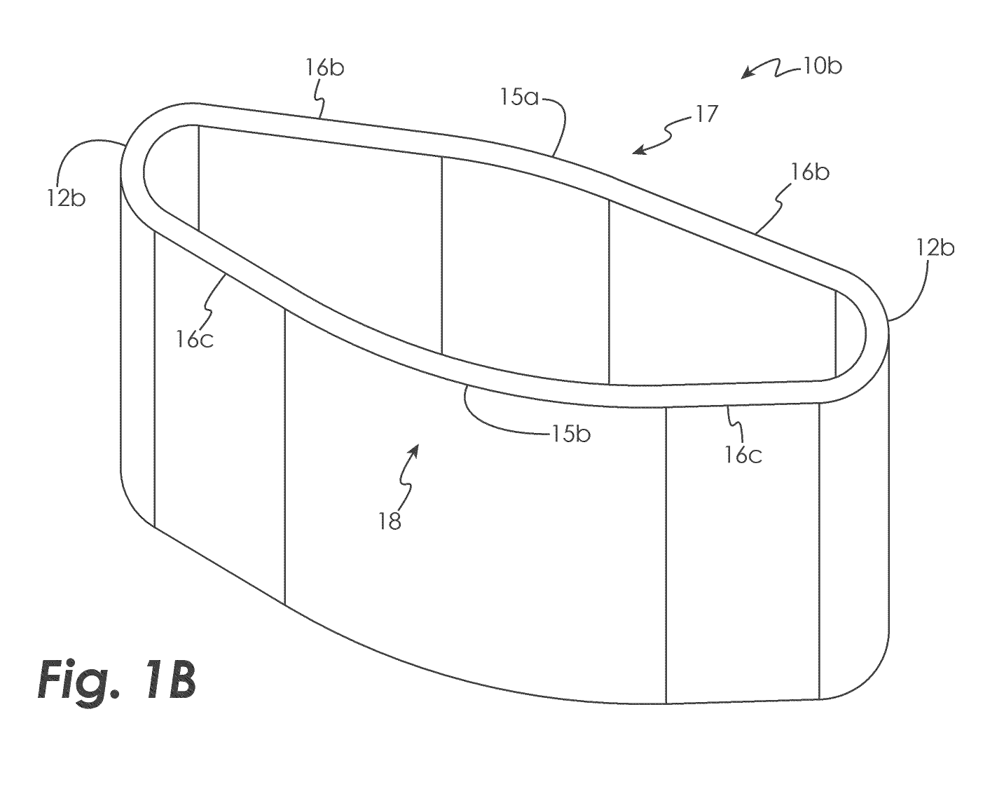

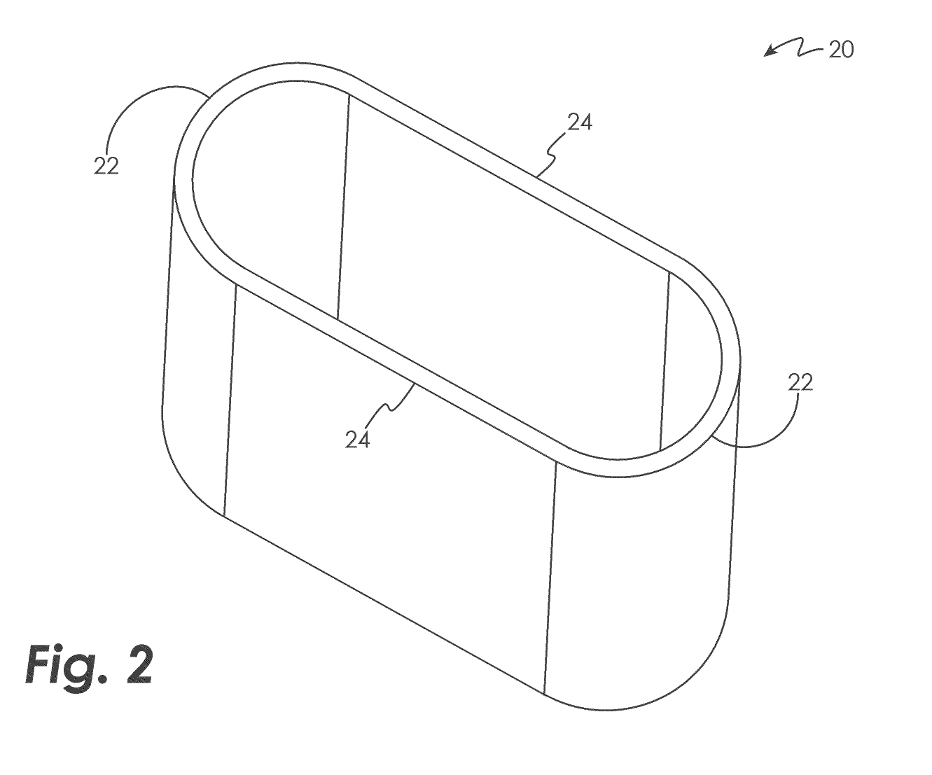

### DETAILED DESCRIPTION OF THE DISCLOSED EMBODIMENTS

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

As used herein, the term “oval” is intended to encompass a smooth, simple (not self-intersecting), convex, closed, plane curve including two unequal axes of symmetry where no three points on the curve are collinear. An ellipse meets the definition of oval as used herein, but not all ovals as defined herein are ellipses.

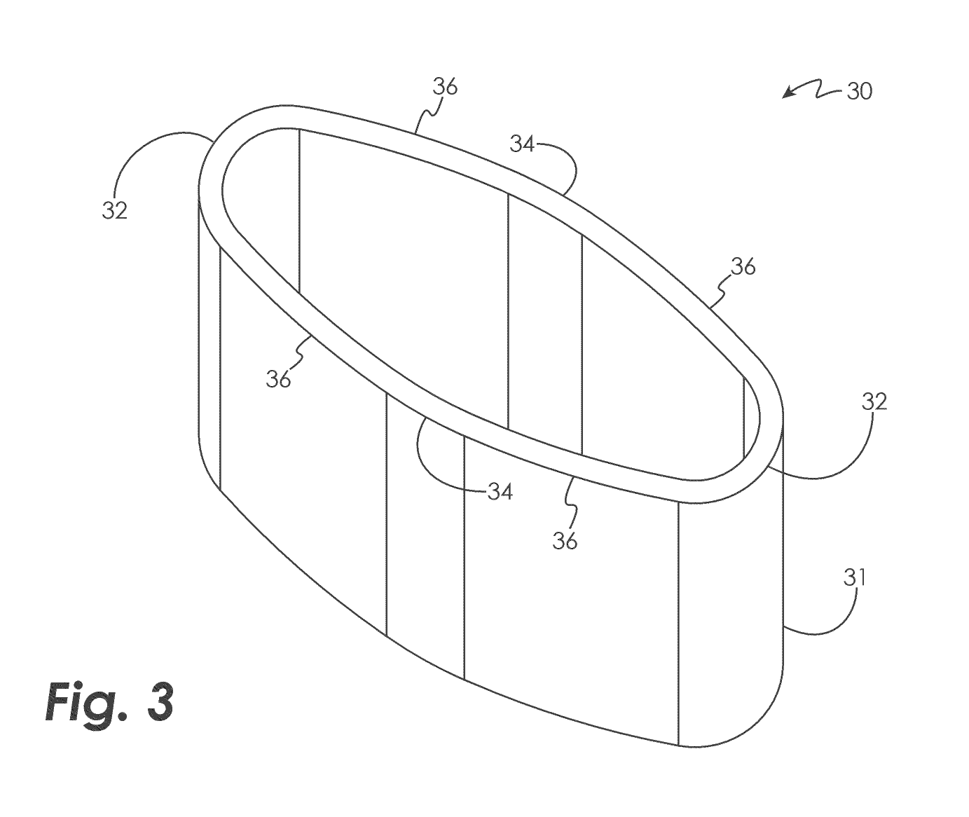

FIG. 3 schematically illustrates a tube design having an oval shaped cross-section and indicated generally at 30. The oval shaped tube 30 comprises a body 31 that includes two sections 32 of a first radius at opposing ends and two sections 34 of a second radius midway between the sections 32. The transitional areas 36 between adjacent sections 32 and 34 are curved. The oval shaped tube 30 has no linear portions in its cross-section.

The oval shaped tube 30 may be formed from any desired process, including extrusion, forming from round tube stock, and forming from flat stock with a welded seam, to name just three non-limiting examples.

The oval shaped tube 30 in an embodiment has greater structural strength than the diamond shaped tube 10 or the racetrack shaped tube 20 because pressure exerted by the fluid carried within the tube is distributed more evenly on the walls of the tube. Because of this, the oval shaped tube 30 in an embodiment may be constructed from lower strength material than that which would be required for the diamond shaped tube 10 or the racetrack shaped tube 20 for any given application. For example, structural analysis of the diamond shaped tube 10 constructed from Inconel® 718 (an austenitic nickel-chromium-based superalloy) determined that the tube was capable of withstanding a baseline number of cycles of predetermined pressures and other loads, whereas an oval shaped tube 30 having the same hydraulic diameter and constructed of Inconel® 625 (another austenitic nickel-chromium-based superalloy) was capable of withstanding more than 30 times the baseline number of cycles at the same predetermined pressures and loads. In other embodiments, the oval shaped tube 30 may be made from other nickel alloys, stainless steel, or titanium, to name just a few non-limiting examples.

In many applications, a transition will have to be made from the specially shaped tube to round tubes. Flow pressure losses are decreased at such transition points from round tubes to the oval shaped tube 30 in an embodiment as compared to the diamond shaped tube 10 or the racetrack shaped tube 20.

The oval shaped tube 30 may be used in any application where it is desired to direct the flow of gases and/or liquids. In the field of gas turbine engines, the oval shaped tube 30 may be used to carry fluids within a cavity in the gas turbine engine. The oval shaped tube 30 may also be used to carry fluids outside the core of a gas turbine engine or as a duct in a gas turbine engine, to name just a few non-limiting examples.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed:

1. A tube comprising:
a tube body having a cross-sectional shape;
wherein the cross-sectional shape comprises an oval.

2. The tube of claim 1, wherein the oval comprises an ellipse.

3. The tube of claim 1, wherein the tube is formed from a process selected from the group consisting of: extrusion, forming from round tube stock, and forming from flat stock with a welded seam.

4. The tube of claim 1 wherein the tube body comprises a material selected from the group consisting of: austenitic nickel-chromium-based superalloy, nickel alloy, stainless steel, and titanium.

5. The tube of claim 1, further comprising:
a gas turbine engine cavity at least partially surrounding the tube body.

6. A gas turbine engine vane, comprising:
an airfoil; and
a tube disposed at least partially within the airfoil, the tube comprising:
a tube body having a cross-sectional shape;
wherein the cross-sectional shape comprises an oval.

7. The gas turbine engine vane of claim 6, wherein the oval comprises an ellipse.

8. The gas turbine engine vane of claim 6, wherein the tube is formed from a process selected from the group consisting of: extrusion, forming from round tube stock, and forming from flat stock with a welded seam.

9. The gas turbine engine vane of claim 6 wherein the tube body comprises a material selected from the group consisting of: austenitic nickel-chromium-based superalloy, nickel alloy, stainless steel, and titanium.

10. A gas turbine engine strut, comprising:
an airfoil; and
a tube disposed at least partially within the airfoil, the tube comprising:
a tube body having a cross-sectional shape;
wherein the cross-sectional shape comprises an oval.

11. The gas turbine engine strut of claim 10, wherein the oval comprises an ellipse.

12. The gas turbine engine strut of claim 10, wherein the tube is formed from a process selected from the group consisting of: extrusion, forming from round tube stock, and forming from flat stock with a welded seam.

13. The gas turbine engine strut of claim 10 wherein the tube body comprises a material selected from the group consisting of: austenitic nickel-chromium-based superalloy, nickel alloy, stainless steel, and titanium.
